(19) United States
(12) Patent Application Publication
(10) Pub. No.: US 2016/0258216 A1
(43) Pub. Date: Sep. 8, 2016

(54) DRILLING MACHINE AND METHOD OF DRILLING

(71) Applicant: JS Innovations LLC, Schererville, IN (US)

(72) Inventors: John Baaske, Dyer, IN (US); Stacy Deming, Dyer, IN (US); Marc W. Pentecost, Valparaiso, IN (US)

(21) Appl. No.: 15/062,727

(22) Filed: Mar. 7, 2016

Related U.S. Application Data
(60) Provisional application No. 62/129,355, filed on Mar. 6, 2015.

(51) Int. Cl. E21B 7/02; B62D 59/04; B60D 1/06

(52) U.S. Cl. CPC E21B 7/028; B60D 1/06; B62D 59/04

(57) ABSTRACT

A drilling machine and method of removing a material from a surface therewith including a frame, a drill secured to the frame, means for removably coupling the frame to a first anchor point comprising a first vehicle adapted to transport the frame, optional means for removably coupling the frame to a second anchor point, and means for forcing the frame in a direction away from the surface such that the frame is rigidly secured between the surface and at least the first anchor point.

### CROSS REFERENCE TO RELATED APPLICATIONS

This application claims the benefit of U.S. Provisional Application No. 62/129,355, filed Mar. 6, 2015, the contents of which are incorporated herein by reference.

### BACKGROUND OF THE INVENTION

The present invention generally relates to drilling machines. The invention particularly relates to mobile drilling machines suitable for producing large diameter circular cuts in a surface.

Core drilling machines utilize cylindrical hollow drill bits having an opening at one end. The drill bits are often specifically designed to produce relatively large diameter circular cuts in a surface. Nonlimiting examples include coring a hole to remove a cylinder of material (core) from a surface, and cutting a groove or channel in which a vehicle detection loop (inductive-loop traffic detector) will be placed. During operation, it is vitally important for the drilling machine to remain stable in order to promote uniform material removal along a cutting edge of the drill bit. Consequently, drilling machines configured for making certain cuts, for example, having a diameter equal to or less than 48 inches (about 120 centimeters), are often mounted to a floor or wall. Drilling machines capable of making larger diameter cuts, for example, greater than 48 inches (about 120 centimeters), are often too large and heavy to be manually transported. Consequently, such large drilling machines (drilling rigs) are conventionally mounted to motor vehicles to provide mobility. Unfortunately, these drilling rigs usually have relatively large and heavy frame constructions which may limit their applicability. For example, they may not be capable of accessing tight or hard to reach areas, may not be suitable for use on surfaces that may be damaged due to excess weight, may not be suitable for indoor use, and may be too large to be lifted by a crane onto a roof of a building. Often large drilling rigs are not suitable for use on rough terrain or elevated structures such as walls and roofs, are expensive, are unable to operate under water, require insurance coverage, and require a commercial driver's license to drive.

In view of the above, it can be appreciated that there are certain problems, shortcomings or disadvantages associated with the prior art, and that it would be desirable if drilling machines were available that are capable of producing large diameter cuts in surfaces, are capable of improved mobility and access relative to conventional drilling machines, and preferably do not need to be secured to the surface being drilled.

### BRIEF DESCRIPTION OF THE INVENTION

The present invention provides drilling machines and methods suitable for making circular cuts in various surfaces. Such drilling machines can preferably be used without being secured to the surface being cut, and preferably provide improved mobility and access relative to conventional drilling rigs.

According to a one aspect of the invention, a drilling machine includes a frame, a drill secured to the frame and configured for removing a material from a surface, means for removably coupling the frame to a first anchor point comprising a first vehicle adapted to transport the frame, optional means for removably coupling the frame to a second anchor point, and means for forcing the frame in a direction away from the surface such that the frame is rigidly secured between the surface and at least the first anchor point.

According to another aspect of the invention, a method of removing material from a surface entails using a drilling machine including a frame and a drill secured to the frame. The method includes removably coupling the frame to a first anchor point comprising a first vehicle adapted to transport the frame, optionally removably coupling the frame to a second anchor point, providing a force on the frame that urges the frame in a direction away from the surface such that the frame is rigidly fixed between the surface and at least the first anchor point, and operating the drill to perform a drilling process to remove the material from the surface.

A technical effect of the invention is the ability of a drilling machine to make circular cuts in a surface without the need to secure the machine to the surface. In particular, it is believed that, by securing the frame of the drilling machine to at least one and preferably two or more vehicles and forcing the frame away from the surface, the drilling machine will be rigidly fixed between the surface and the vehicle(s). Consequently, the drilling machine may be securely stabilized during the drilling operation on the surface without the need to secure the drilling machine directly to the surface.

Other aspects and advantages of this invention will be better appreciated from the following detailed description.

### BRIEF DESCRIPTION OF THE DRAWINGS

FIG. 1 is a perspective view of a frame of a drilling machine with a drill mounted thereon and secured to a host vehicle in accordance with certain aspects of the invention.

FIGS. 2 and 3 are side and top, respectively, representing the frame of the drilling machine of FIG. 1 with the drill mounted thereon.

FIG. 4 is a side view of the drilling machine of FIG. 1 secured between two host vehicles.

FIG. 5 represents an isolated top view of a core drilling bit of FIG. 4 as supported by wheel assemblies located around a perimeter thereof.

FIG. 6 represents a side view of the drilling machine of FIG. 1 as located against a vertical wall for drilling a hole therein in accordance with certain aspects of the present invention.

FIG. 7 represents an isolated top view of a core drilling bit of FIG. 6 as supported by wheel assemblies located around a perimeter thereof.

FIG. 8 represents a side view of the drilling machine of FIG. 1 as located underwater for drilling a hole in a submerged surface in accordance with certain aspects of the present invention.

FIGS. 9 and 10 represent a frame of a drilling machine, expanded and contracted, respectively, in accordance with certain aspects of the invention.

FIGS. 11 through 13 represent the drilling machine of FIGS. 9 and 10 with a drill bit, a drill mast, and a secondary connection mounted thereon.

### DETAILED DESCRIPTION OF THE INVENTION

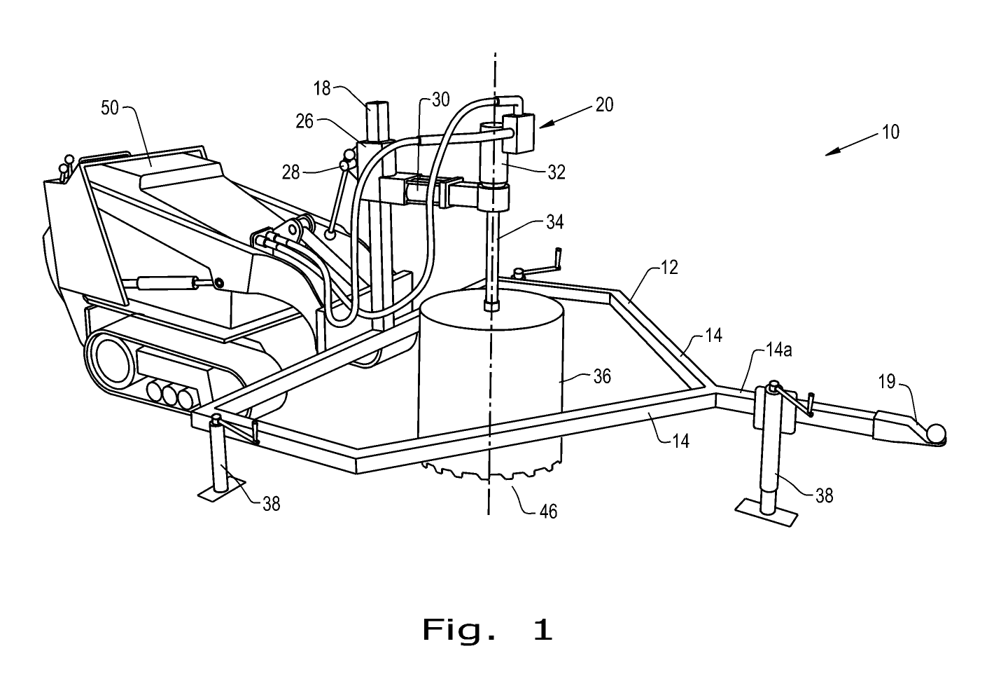

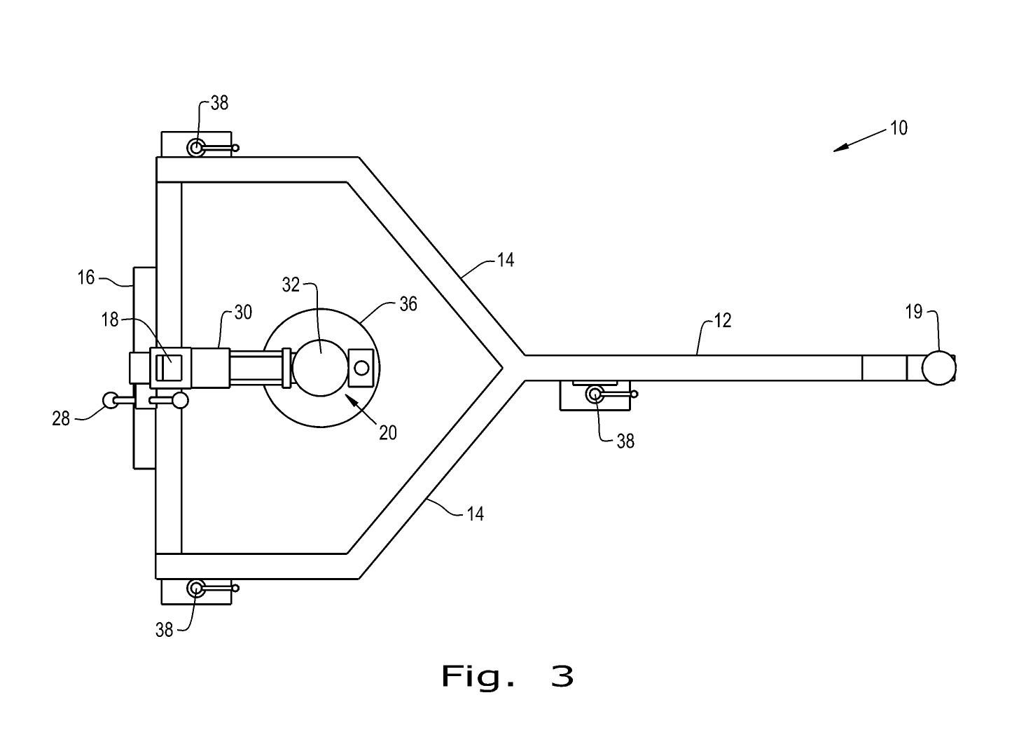

FIGS. 1 through 4 represent certain aspects of a drilling machine (rig) suitable for supporting a drill and configured to be removably coupled with one or more vehicles. Aspects of the invention are described hereinafter in reference to a drilling rig 10 configured to couple with a skid-steer utility loader and support a large bore core drill. It is within the scope of the invention that the drilling rig 10 may be further configured to removably couple to any type of vehicle suitable for supporting, lifting, and/or transporting the drilling rig 10. Such vehicles include, but are not limited to, motorized vehicles commonly used in construction, for example, pickup and flatbed trucks. It is also within the scope of the invention that the drilling rig 10 may be configured to support any type of drill or other similar cutting device known in the art.

According to one nonlimiting aspect of the invention, the drilling rig 10 may be configured to produce relatively large diameter circular cuts in a surface using a core drill bit. Such a cut may be, for example, for coring a hole by removing a cylinder of material (core) from a surface, or cutting a groove or channel in which a vehicle detection loop will be placed. Stability is an especially important factor when drilling large diameter cuts, for example, having diameters of greater than 48 inches (about 120 centimeters). Unstable drilling may lead to binding between the material being cut and the drill bit, or may lead to an uneven cut. Investigations leading to the present invention utilized a hydraulic drill capable of forming circular cuts having diameters of up to 72 inches (about 180 centimeters) in a surface of asphalt, concrete, or the like. The hydraulic drill used in these investigations was water cooled, configured to handle up to 20 gallons (about 75 liters) of hydraulic oil per minute at 2000 psi (about 14 Mpa).

FIGS. 1 through 4 represent the drilling rig 10 as having a construction comprising segments 14 secured together to form a rigid frame 12 of the drilling rig 10. The segments 14 are represented as being rectangular-shaped metal tubes welded together at respective ends thereof. As a nonlimiting example, during investigations leading to the present invention a frame 12 was built using 2.5×2.5 inches (about 6×6 cm) square tubing with rolled edges. It is foreseeable that the segments 14 may be of any shape and secured to one another in any suitable manner and by any suitable means that will yield a rigid support structure for supporting, interacting with, and/or stabilizing a drill and drill bit capable of producing a large diameter cut. For example, it is foreseeable that the segments 14 may be secured in a manner such that the frame 12 may be disassembled and/or collapsible. The frame 12 represented in the Figures comprises five segments 14 secured to form a generally pentagon-shaped rigid support structure that defines a drilling area below, within, and around its boundary and further comprises a sixth segment 14a projecting in a direction away from the drilling area. For example, smaller drill bits (for example, 48 inch diameter) may be located entirely within the boundary of the frame 12 as represented in FIG. 1; however, larger drill bits (for example, 72 inch diameter) may extend beyond the boundary of the frame. Such a situation is entirely dependent on the size of the frame 12 and the size of the drill bit being used. To accommodate drill bits that are larger than the boundary of the frame 12, the drill bits may be configured to fit below a clearance of the frame 12, that is, between the frame 12 and the surface to be drilled. It is within the scope of the invention that the frame 12 may comprise any number of segments 14 and the segments 14 may be secured to one another to define a frame 12 of any shape or size suitable for supporting, interacting with, and/or stabilizing a drill secured to the frame 12.

According to a preferred but nonlimiting aspect of the invention, the drilling rig 10 is adapted to be securely and rigidly coupled to at least one and preferably two anchor points. The drilling rig 10 comprises a mounting plate 16 secured to one of the segments 14, preferably on a side of the frame 12 oppositely disposed from the segment 14a projecting from the drilling area. The mounting plate 16 may be of any shape suitable for removably but rigidly coupling the frame 12 of the drilling rig 10 to a first anchor point, preferably a “host” machine or vehicle 50, which may be, for example, a motorized utility vehicle (FIG. 1). The host vehicle 50 is preferably adapted to lift and/or solely support the drilling rig 10 and transport the drilling rig 10 between desired locations. The mounting plate 16 may be a universal mounting plate that is suitable for individually coupling with a plurality of types of host vehicles 50, or may be a mounting plate or other type of connection configured to couple with a specific brand or type of host vehicle 50.

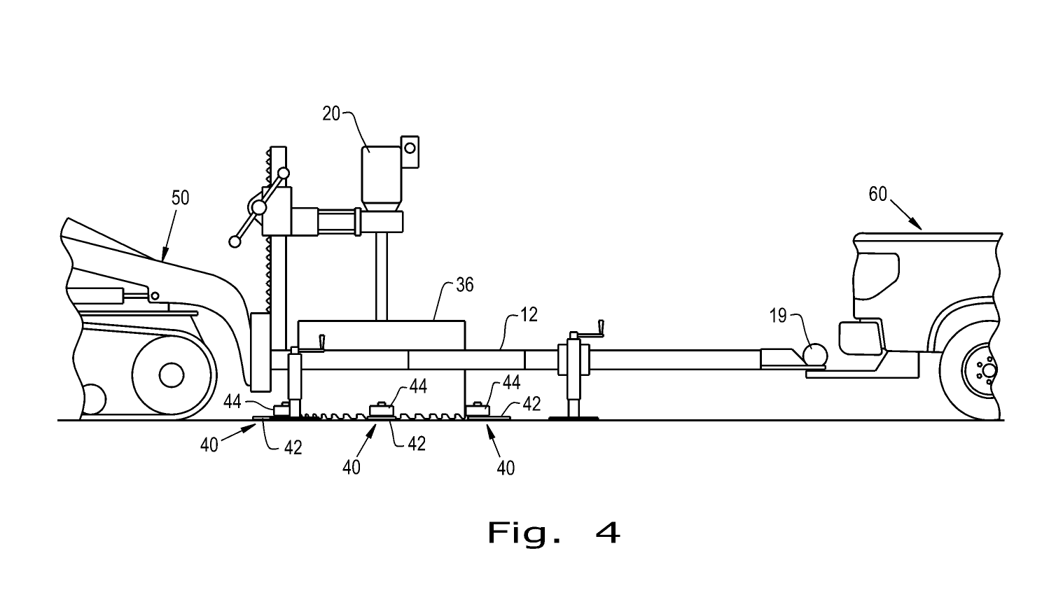

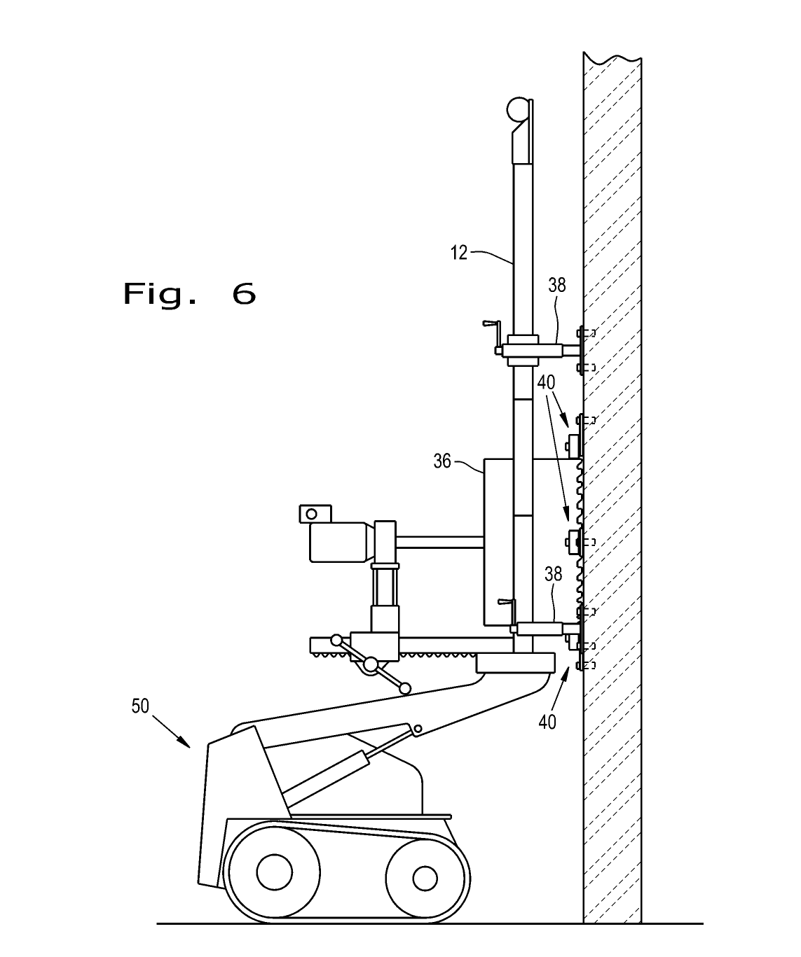

The embodiment of the rig 10 shown in FIGS. 1 through 4 is equipped with a connection (hitch) 19 located on the segment 14a projecting from the drilling area, preferably on a side of the frame 12 oppositely-disposed from the mounting plate 16. The connection 19 is an optional but preferred feature that provides additional support to the drilling rig 10 during operation. The connection 19 may comprise any type of hitch or coupler suitable for removably but rigidly coupling the frame 12 of the drilling rig 10 to a second anchor point, preferably a vehicle 60 (“secondary vehicle”) that is in addition to the first anchor point, e.g., the host vehicle 50. More broadly, the connection 19 may be adapted to rigidly couple the frame 12 to any structure suitable for providing a fixed and stable structure for stabilizing the rig 10 and its frame 12. For example, FIGS. 1 and 6 represent the drilling rig 10 as comprising a trailer-type hitch of a type well know in the art and configured to cover and removably secure to a ball-type hitch commonly found on passenger and commercial vehicles for towing trailers. Such a configuration provides the ability for the frame 12 to removably couple to a rear portion of the secondary vehicle 60, such as a pickup truck, and thereby achieve additional stability to the frame 12 as represented in FIG. 4.

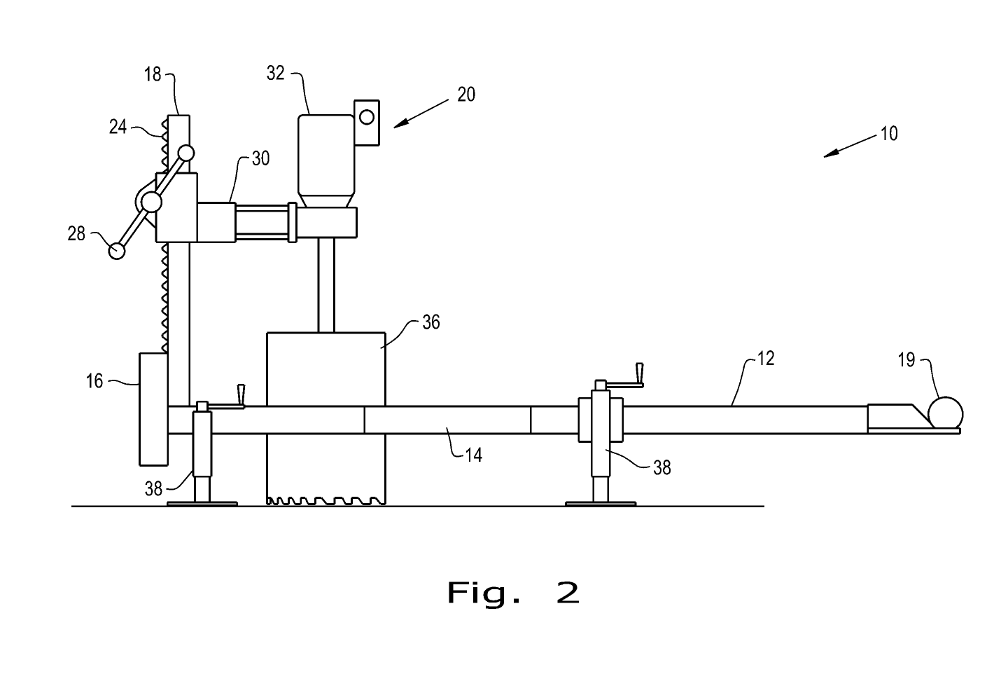

The drilling rig 10 is also shown as comprising a drill mast 18 configured to support a drill 20, for example, a hydraulic drill of the type noted above. As best seen in FIG. 2, an exemplary drill mast 18 comprises a vertically-disposed (relative to ground) rectangular-shaped metal tube secured at a lowermost end thereof to the frame 12 near the mounting plate 16. The embodiment of the drill mast 18 shown in FIGS. 1 and 4 comprises a plurality of teeth 24 located on a side of the mast 18 and disposed along a longitudinal axis of the mast 18. The teeth 24 are configured to interact with a mount 26 secured to the drill 20 such that the drill 20 may be raised or lowered relative to the longitudinal axis of the mast 18. Preferably the mount 26 is configured such that the drill 20 may be removably coupled to the mast 18. FIG. 2 represents the mount 26 as being configured to slide over the uppermost end of the mast 18 and be selectively secured along the longitudinal axis of the mast 18 by interacting with the plurality of teeth 24, for example, through a pinion (not shown) associated with the mount 26. In the nonlimiting embodiment shown in FIG. 2, the mount 26 includes a crank lever 28 adapted to rotate the pinion to raise or lower the mount 26 on the mast 18. A beam 30 rigidly connects the mount 26 to a housing 32 of the drill 20. The housing 32 may contain internal components of the drill 20 suitable for rotating a spindle 34 and a core drill bit 36 secured thereto, by which a drilling action can be performed on a surface 46 beneath the frame 12 and within the drilling area to remove material from the surface 46 within or below the drilling area. Other types of drills, means for securing drills to the mast 18, means for raising and lowering drills along the longitudinal axis of the mast 18, as well as other means for raising and lowering a drill relative to the frame 12, are within the capabilities of those skilled in the art and within the scope of the present invention.

The drilling rig 10 preferably comprises one or more legs 38 configured to vertically support the frame 12 of the drilling rig 10 from beneath. The nonlimiting embodiment shown in FIGS. 1 through 4 has three legs 38 secured to the segments 14. Each leg 38 is of a type common in the field of trailers (e.g., standard trailer jacks) and are configured to reversibly rotate between a horizontal position and a vertical position (relative to ground) as well as to extend along a longitudinal axis thereof. The legs 38 may be of any type suitable for supporting and securing the drilling rig 10 during operation of the drill 20 and, in accordance with a preferred aspect of the invention, generating a force on the frame 12 to urge the frame 12 away from the surface 46 being cut with the bit 36 such that the frame 12 can be rigidly fixed between the surface 46 and two anchor points, e.g., the vehicles 50 and 60.

FIG. 4 represents the drilling rig 10 during operation. The drilling rig 10 may be secured to the host vehicle 50 as the first anchor point, which in preferred embodiments of the invention can also be used to transport the drilling rig 10, preferably including the frame 12, drill 20, and drill bit 36, to a specific location and position the drill bit 36 over a desired area to be drilled. In addition, the connection 19 may be secured to the secondary vehicle 60 or other suitable structure as a second anchor point to provide additional stability. The legs 38 may then be rotated from the horizontal position to the vertical position and lowered to the ground (or extended to the surface 46) to stabilize the drilling rig 10. The legs 38 are preferably further extended against the surface 46 in order to force the frame 12 in a direction away from the surface 46. By providing such force, the frame 12 will be forced upward against the weight of the host vehicle 50 at the mounting plate 16 and upward against the weight of the secondary vehicle 60 at the connection 19, such that the frame 12 is rigidly fixed between the surface 46 and the vehicles 50 and 60 by at least a portion of the weight of each vehicle 50 and 60 borne by the legs 38. Consequently, the mounting plate 16 and the connection 19 may be viewed as anchoring points that stabilize the drilling rig 10 during operation of the drill 20.

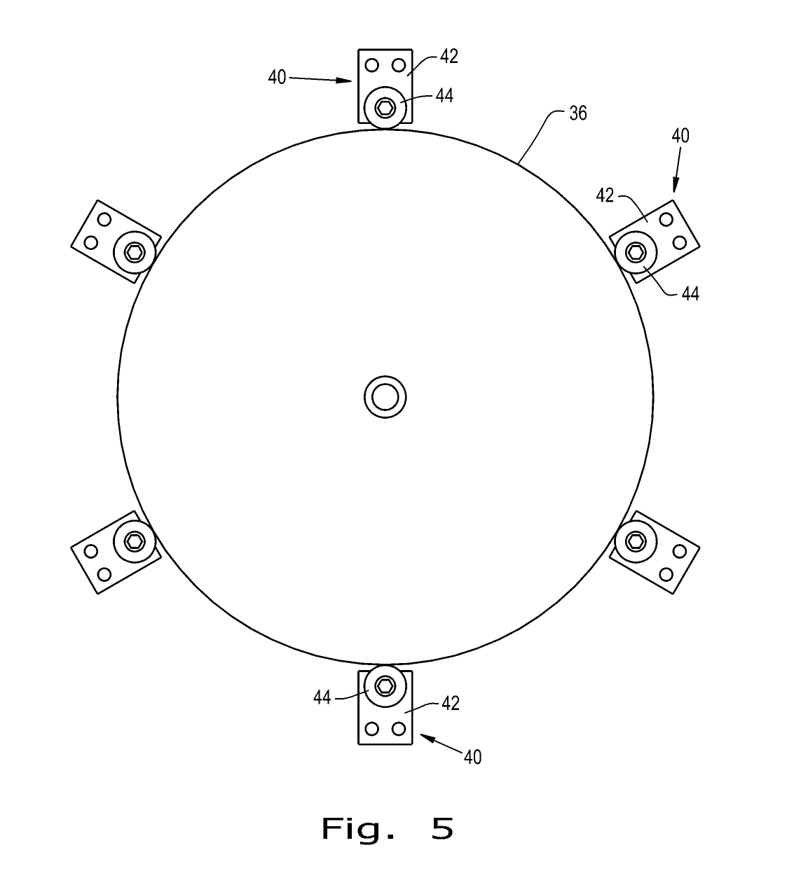

The drill 20 may be coupled and vertically positioned on the drill mast 18 of the drilling rig 10 with the mount 26. According to a nonlimiting aspect of the invention, the drill 20 may be powered by the host vehicle 50 or, if utilized, the secondary vehicle 60. During operation, the drill 20 operates to rotate the drill bit 36 and thereby remove material from the surface 46 located below the drilling area. Therefore, the frame 12 of the drilling rig 10 may be stabilized by the host vehicle 50, the secondary vehicle 60 or other suitable structure, and the legs 38. The drill bit 36 may be further stabilized during rotation with wheel plates 40, as depicted in FIGS. 4 and 5. The wheel plates 40 include a base 42 and a wheel 44 rotatably attached to the base 42. One or more of the wheel plates 40 may be located around the perimeter of the drill bit 36 such that the wheel 44 of each individual wheel plate 40 is rotatably in contact with an exterior surface of the drill bit 36. Each wheel plate 40 is shown in FIGS. 4 and 5 as securely fixed to the surface 46 undergoing cutting with the drill bit 36, although it is also foreseeable that the wheel plates 40 could be coupled to the frame 12. The wheel plates 40 may be located around the perimeter of the drill bit 36 such that the drill bit 36 has generally uniform radial support along the perimeter thereof.

As material is removed from the surface 46 below the drilling area, the drill 20 and drill bit 36 may be lowered with the lever 28 of the mount 26. Operation of the drill 20 may include additional steps common to drilling processes such as cooling the drill bit 36 with water. Such additional steps are well known in the art and will not be discussed further herein. After the drill bit 36 has sufficiently penetrated the surface 46 below the drilling area to a desired depth, the drill 20 and drill bit 36 may be raised clear of an uppermost portion of the surface 46 with the lever 28. It may be desirable to remove the wheel plates 40 to no longer be in contact with the drill bit 36 prior to raising the drill bit 36. The connection 19 may be de-coupled from the secondary vehicle 60 (or other structure) and the legs 38 may be raised and rotated to the horizontal position. The drilling rig 10 may then be lifted, if necessary, with the host vehicle 50 and transported to a different location, thereby exposing the circular cut produced by the drill 20 in the surface 46.

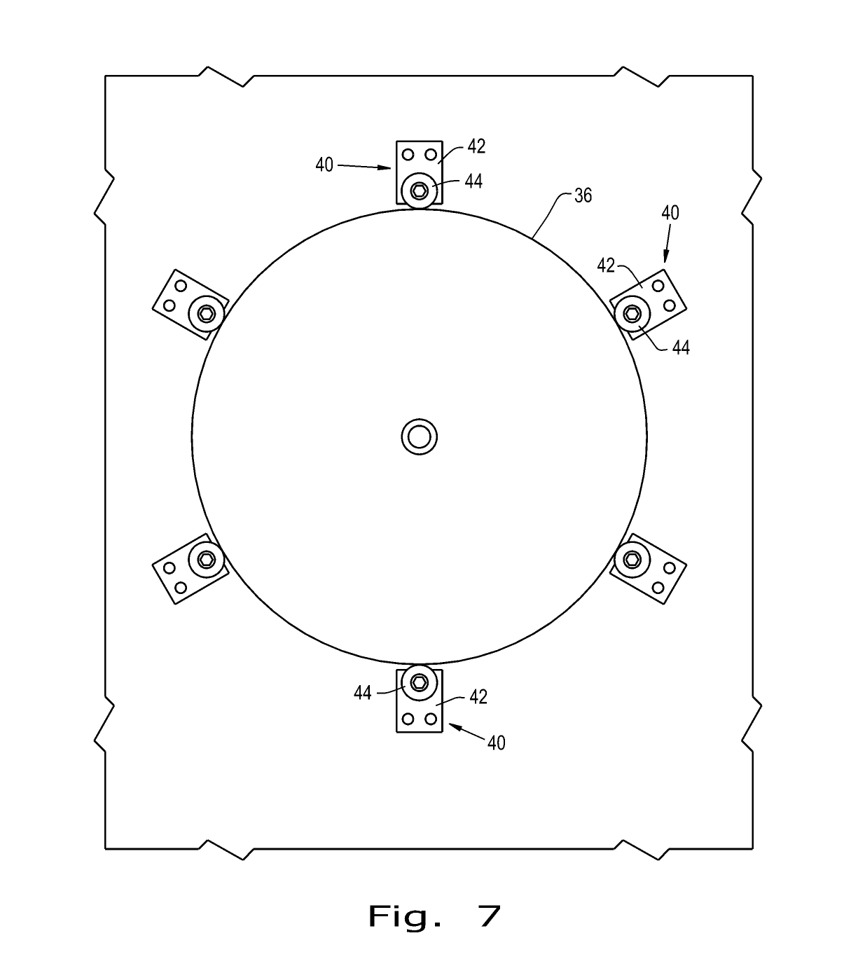

According to a nonlimiting aspect of the invention, the surface to be drilled may be an elevated structure, such as but not limited to a wall. For example, FIG. 6 represents a vertical wall (about 90 degrees to ground) being drilled by positioning the drilling rig 10 with the host vehicle 50 such that the axis of rotation of the drill bit 36 is, for example, about 90 degrees to ground. The legs 38 may be extended towards the wall such that the frame 112 is forced in a direction away from the wall. Consequently, the frame 112 is rigidly secured between at least the host vehicle 50 and the wall during operation of the drill 20. In addition, anchors may be inserted into the wall through holes in the legs 38 in order to provide additional stability. FIG. 7 represents the drill bit 36 as being surrounded and supported by the wheel plates 40 anchored to the wall which may provide additional support to the drill bit 36.

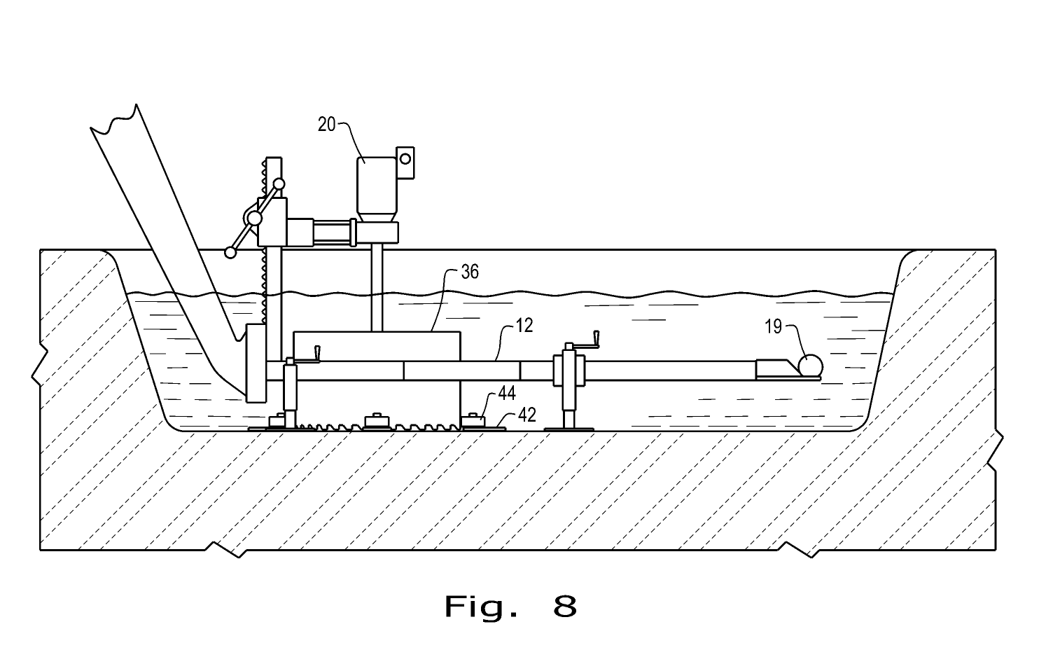

According to a nonlimiting aspect of the invention, the drilling rig 10 may provide the ability to drill surfaces submerged below a body of water. Whereas conventional drilling assemblies or rigs may require an operator or the vehicle to be underwater, the drilling rig 10 may be secured to, for example, a boom end of a backhoe, lift, telescopic handler/telehandler, cherry picker, or the like (host vehicle 50) which may then be used to lower only the drilling rig 10 and boom under water while the vehicle 50 and the operator remain above water, as represented in FIG. 8.

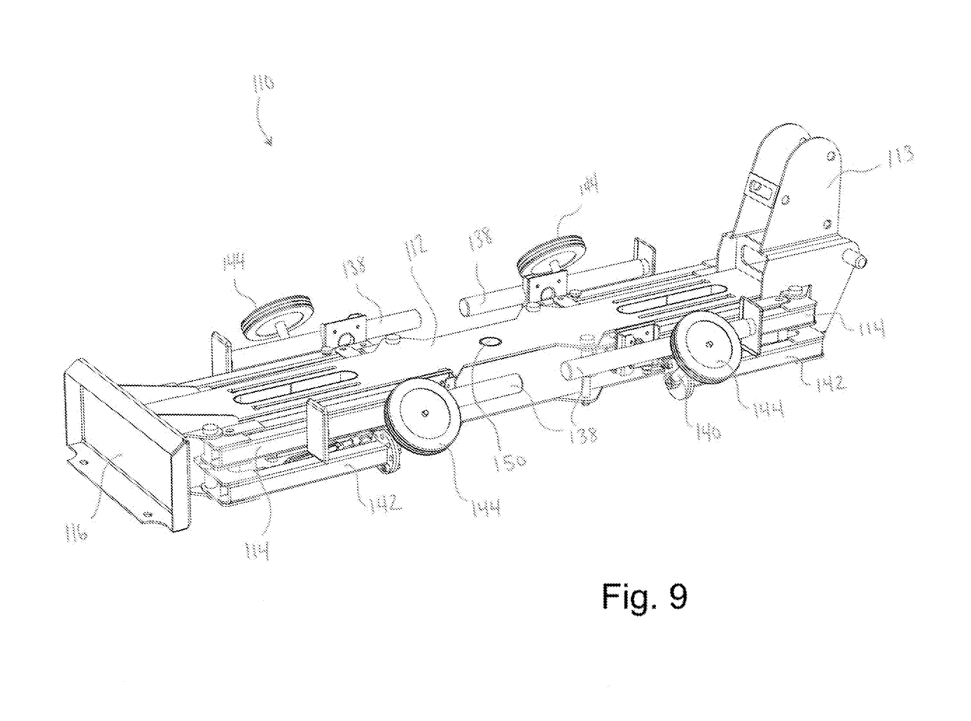

FIGS. 9 through 13 represent an alternative drilling rig 110 having substantially the same functionality as the drilling rig 10. As with the embodiment represented in FIGS. 1-8, the drilling rig 110 may be secured to the drill 20 and the drill bit 36 in order to produce relatively large diameter circular cuts in a surface. The drilling rig 110 includes an elongated frame 112 that is preferably configured to be securely and rigidly coupled to at least one and preferably two anchor points, similar to the drilling rig 10. As such, the frame 112 includes a primary mounting plate 116 and a secondary connection 113 located on oppositely-disposed ends of the frame 112. The mounting plate 116 may be of any shape suitable for removably but rigidly coupling the frame 112 of the drilling rig 110 to a first anchor point, preferably a “host” machine or vehicle 50, which may be, for example, the motorized utility vehicle represented in FIG. 1. The host vehicle 50 is preferably adapted to lift and/or solely support the drilling rig 110 and transport the drilling rig 110 between desired locations. The mounting plate 116 may be a universal mounting plate that is suitable for individually coupling with a plurality of types of host vehicles 50, or may be a mounting plate or other type of connection configured to couple with a specific brand or type of host vehicle 50.

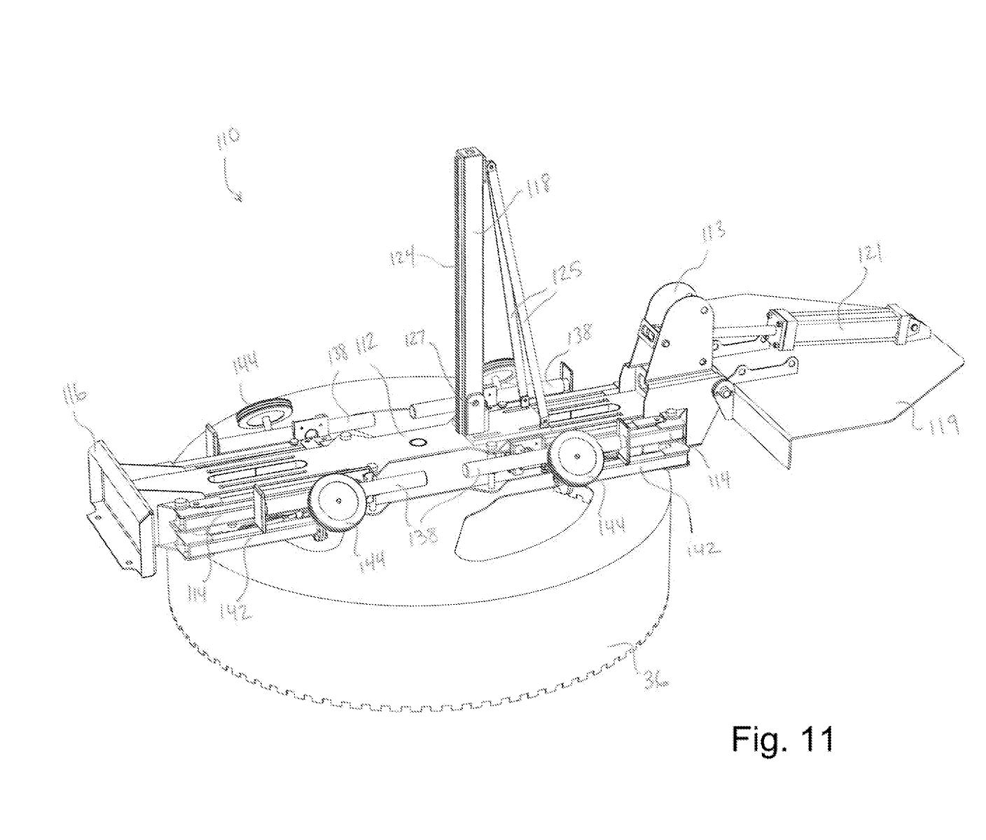

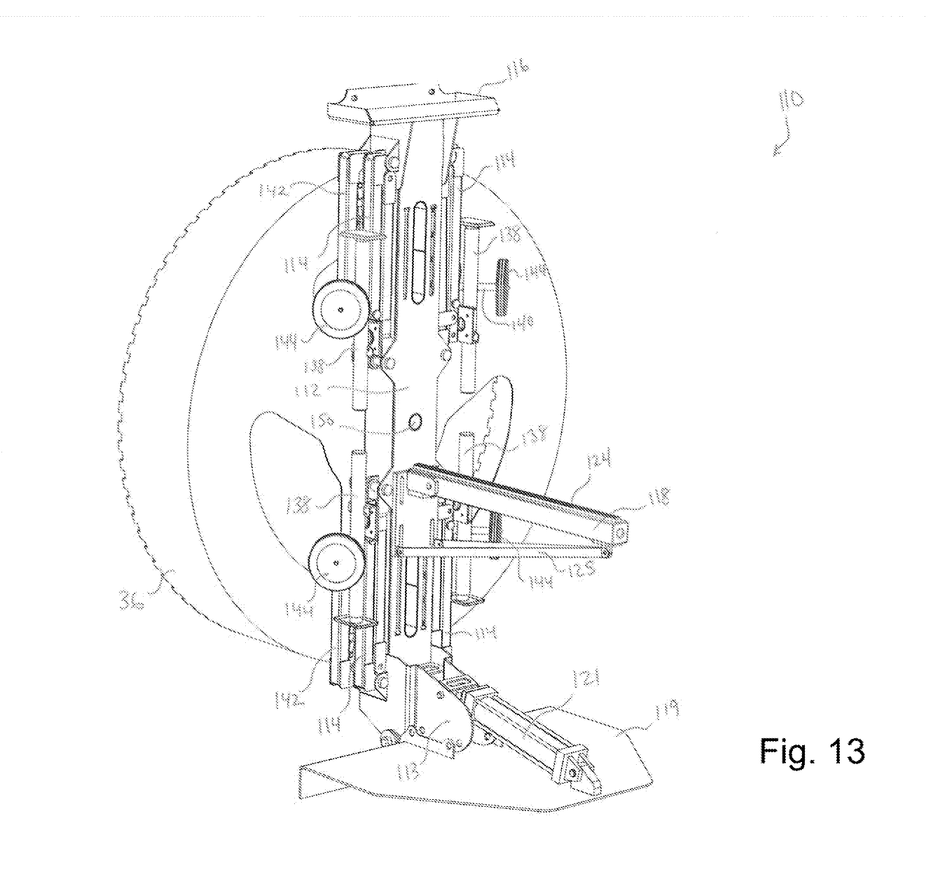

The secondary connection 113 is an optional but preferred feature that provides additional support to the drilling rig 110 during operation, and may further be used for transportation of the drilling rig 110. The secondary connection 113 may comprise any type of hitch or coupler suitable for removably but rigidly coupling the frame 112 of the drilling rig 110 to a second anchor point, preferably a vehicle 60 (“secondary vehicle”) that is in addition to the first anchor point, e.g., the host vehicle 50. More broadly, the secondary mounting plate 119 may be adapted to rigidly couple the frame 112 to any structure suitable for providing a fixed and stable structure for stabilizing the rig 110 and its frame 112. For example, FIGS. 11 through 13 represent the secondary connection 119 as comprising a hydraulic plate hitch 119 configured to removably secure to a plate-type hitch (not shown) commonly found on passenger and commercial vehicles. Such a configuration provides the ability for the frame 112 to removably couple to a rear portion of the secondary vehicle 60, such as a pickup truck, and thereby achieve additional stability to the frame 12. In addition, when the drilling rig 110 is connected to the secondary vehicle 60 but not connected to the host vehicle 50, hydraulics 121 of the plate hitch 119 may be operated to lift the drilling rig 110 into a vertical or elevated position such that the drilling rig 110 may be transported with the secondary vehicle 60, as represented in FIG. 13.

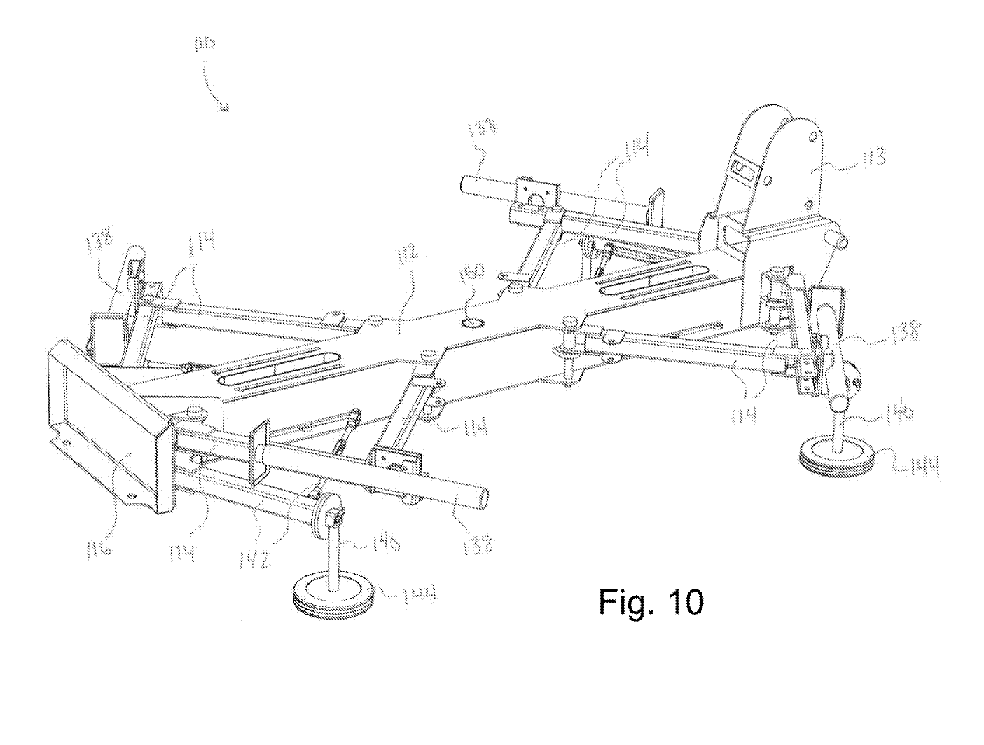

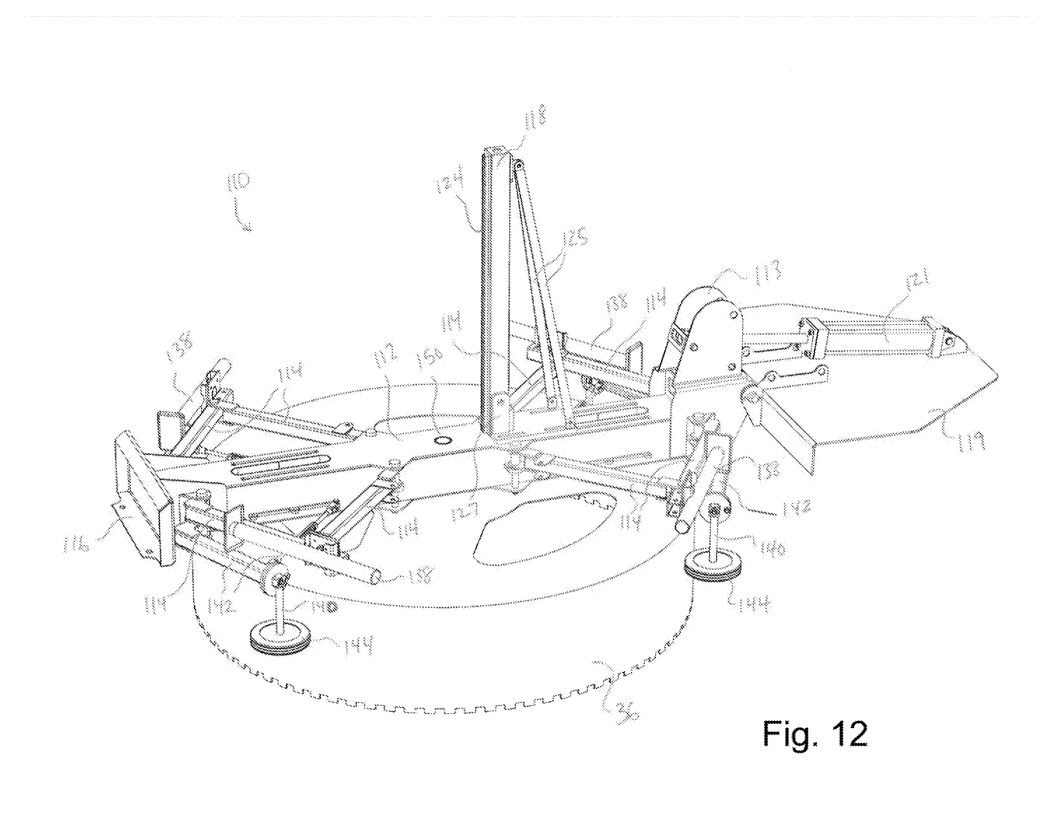

The drilling rig 110 preferably comprises one or more legs 138 configured to vertically support the frame 112 of the drilling rig 110 from beneath. The nonlimiting embodiment shown in FIGS. 9 through 13 has four legs 138 secured to the frame 112. Each leg 138 is configured to reversibly rotate between a horizontal position and a vertical position (relative to ground), to expand away from and contract towards the frame 112 using extension members 114, and to extend along a longitudinal axis of the leg 138. The legs 138 may be of any type suitable for supporting and securing the drilling rig 110 during operation of the drill 20 and, in accordance with a preferred aspect of the invention, generating a force on the frame 112 to urge the frame 112 away from the surface being cut with the bit 36 such that the frame 112 can be rigidly fixed between the surface and two anchor points, e.g., the vehicles 50 and 60. FIGS. 10 and 12 represent the legs 138 as extended away from the frame 112. FIGS. 9, 11, and 13 represent the legs 138 as contracted towards the frame 112, rotated to the horizontal position, and contracted along the longitudinal axis.

According to preferred but nonlimiting aspects of the invention, the drilling rig 110 includes one or more wheel assemblies secured to the frame 112 which are configured to stabilize the drill bit 36 during operation in substantially the same manner as wheel plates 40 in regards to the drilling rig 10. Each of the wheel assemblies include extension members 142, a positioning member 140, and a wheel 144. The wheel assemblies are configured to reversibly rotate between a horizontal position and an upward position (relative to ground), and may expand away from and contract towards the frame 112 using extension members 142. As represented in FIG. 12, when the drill bit 36 is attached to the drilling rig 110 and the drilling rig 110 is in an expanded operating position, the wheel assemblies may be located around the perimeter of the drill bit 36 such that the wheel 144 of each individual wheel assembly is rotatably in contact with an exterior surface of the drill bit 36. The wheel assemblies may be located around the perimeter of the drill bit 36 such that the drill bit 36 has generally uniform radial support along the perimeter thereof.

FIGS. 11 through 13 represent the drilling rig 110 as including a drill mast 118 secured to an upper surface (relative to ground) of the frame 112 at a first end of the drill mast 118 and protruding in a direction away from the frame 112. The drill mast 118 may be supported with support members 125 and 127, and preferably, the drill mast 118 is configured to be removably secured to the frame 112 and/or rotatably secured to the frame 112 such that the drill mast 118 may collapse towards the frame 112 for transportation and storage. As with the previous embodiment represented in FIGS. 1 through 8, the drill 20 may be coupled and vertically positioned on the drill mast 118 of the drilling rig 110 with the mount 26. The spindle 34 of the drill 20 may be located to pass through a hole 150 in the frame 112 in order to functionally couple with the drill bit 36.

During operation, the drilling rig 110, the drill 20, and the drill bit 36 may be transported and positioned with the host vehicle 50 or secondary vehicle 60. Once in the expanded operational position, as represented in FIG. 12, the drilling rig 110 may be utilized in substantially the same manner as previously described regarding the embodiment represented in FIGS. 1 through 6, that is, the drilling rig 110 may be secured to one or more anchoring points, the drilling rig 110 may be stabilized by extending the legs 138 as to force the frame 112 in a direction away from the surface, and then the drill 20 may be operated to remove material from the surface.

According to a nonlimiting aspect of the invention, the surface to be drilled may be an elevated structure, such as but not limited to a wall. For example, a vertical wall (about 90 degrees to ground) may be drilled by positioning the drilling rig 110 with the host vehicle 50 such that the axis of rotation of the drill bit 36 is, for example, about 90 degrees to ground as represented in FIG. 13. The legs 138 may be extended towards the wall such that the frame 112 is forced in a direction away from the wall. Consequently, the frame 112 may be rigidly secured between at least the host vehicle 50 and the wall during operation of the drill 20. In addition, anchors may be inserted into the wall through holes in the legs 138 in order to provide additional stability. In addition, the rig 110 may provide the ability to drill surfaces submerged below a body of water. In substantially the same manner represented in FIG. 8 in regards to rig 10, the drilling rig 110 may be secured to, for example, a boom end of a backhoe, lift, telescopic handler/telehandler, cherry picker, or the like (host vehicle 50) which may then be used to lower only the drilling rig 110 and boom under water while the vehicle 50 and the operator remain above water.

In view of the above, the drilling rigs 10 and 110, which may be viewed as attachments for the host vehicle 50, have as structures that are generally much smaller, lighter, and more compact that conventional drilling rigs, particularly core drilling rigs. Consequently, the drilling rigs 10 and 110 provide improved mobility, improved access to tight or difficult to reach areas, may be suitable for indoor use (may be disassembled to fit through a standard size doorway), may be lifted by a crane onto a roof of a building, have reduced manufacturing costs, likely do not require a commercial driver's license, etc. The ability of the drilling rigs 10 and 110 to be rigidly fixed between a surface 46 and one or more anchoring points (such as the vehicles 50 and 60), rather than solely relying on the weight of the drilling rigs 10 or 110 themselves, or the need to be directly attached to the surface 46, promotes the ability of the drilling rigs 10 and 110 to operate on rough, uneven terrain or even be used to cut circular cuts in an elevated structure, such as a wall. In addition, the drilling rigs 10 and 110 provide the ability to more easily drill underwater surfaces. The drilling rigs 10 and 110 preferably are configured to produce circular cuts having diameters between, for example, 1 to 72 inches (about 2 to 180 centimeters) from a wide variety of materials, for example, concrete, asphalt, or the like, from a wide variety of surfaces 46, for example floors, roads, walls, roofs, bank vaults, bridge decks, etc.

While the invention has been described in terms of specific embodiments, it is apparent that other forms could be adopted by one skilled in the art. For example, the drilling rigs 10 and/or 110 could differ in appearance and construction from the embodiments shown in the Figures, the functions of each component of the drilling rigs 10 and/or 110 could be performed by components of different construction but capable of a similar (though not necessarily equivalent) function. Therefore, the scope of the invention is to be limited only by the following claims.

1. A drilling machine comprising:
a frame;
a drill secured to the frame and configured for removing a material from a surface;
means for removably coupling the frame to a first anchor point comprising a first vehicle adapted to transport the frame;
optional means for removably coupling the frame to a second anchor point; and
means for forcing the frame in a direction away from the surface such that the frame is rigidly secured between the surface and at least the first anchor point.

2. The drilling machine of claim 1, wherein the drill is removably coupled to the frame.

3. The drilling machine of claim 1, wherein the drill is powered by the first vehicle.

4. The drilling machine of claim 1, wherein the frame is defined by a plurality of segments.

5. The drilling machine of claim 1, wherein the first vehicle is configured to lift and transport the frame when the frame is coupled to the first vehicle and not coupled to the second anchor point.

6. The drilling machine of claim 1, wherein the means for removably coupling the frame to the first vehicle is a mounting plate and the first vehicle is a motorized utility vehicle.

7. The drilling machine of claim 6, wherein the first vehicle is a skid-steer utility loader.

8. The drilling machine of claim 1, wherein the drill comprises a drill bit suitable for producing a circular cut in the surface.

9. The drilling machine of claim 8, wherein the circular cut is greater than about 120 centimeters.

10. The drilling machine of claim 1, wherein the means for forcing the frame in a direction away from the surface includes at least one extendable leg secured to the frame, wherein extending the leg beyond the distance between the frame and the surface forces the frame in a direction away from the surface.

11. The drilling machine of claim 1, wherein the drilling machine comprises the means for removably coupling the frame to the second anchor point and the second anchor port is a second vehicle.

12. The drilling machine of claim 1, wherein the frame is configured to collapse to a first position such that components of the frame are located at a minimum distance from the frame and configured to expand to a second position such that the components of the frame are located at a maximum distance from the frame.

13. The drilling machine of claim 1, further comprising one or more wheel assemblies secured to the frame and configured to be located around a perimeter of the drill bit, each wheel assembly comprising a wheel rotatably attached thereto, the wheel of each wheel assembly being near or in contact with an exterior surface of the drill bit.

14. The drilling machine of claim 1, wherein the surface is a wall.

15. The drilling machine of claim 1, wherein the surface is underwater.

16. A method of removing material from the surface using the drilling machine of claim 1, the method comprising:
coupling the frame to the first vehicle;
coupling the frame to the second anchor point;
providing a force on the frame in a direction away from the surface such that the frame is rigidly secured between the surface and the first and second anchor points; and
operating the drill to perform a drilling process to remove the material from the surface.

17. The method of claim 16, further comprising:
lifting the drilling machine with the first vehicle after coupling the frame to the first vehicle; and
transporting to the surface with the first vehicle before coupling the frame to the second anchor point.

18. The method of claim 16, wherein providing the force in the direction away from the surface includes extending at least one extendable leg secured to the frame such that an end of the leg contacts the surface and forces the frame in a direction away from the surface.

19. The method of claim 16, wherein the drill comprises a drill bit suitable for producing circular cuts in the surface, the circular cuts having diameters that are greater than about 120 centimeters.

20. The method of claim 16, further comprising:
locating a plurality of wheel plates on the surface and at locations around the perimeter of the drill bit, each wheel plate comprising a wheel rotatably attached thereto, the wheel of each wheel plate being near or in contact with an exterior surface of the drill bit; and
securing the wheel plates to the surface.

21. The method of claim 17, wherein the first vehicle is a skid-steer utility loader.

22. A method of removing material from a surface using a drilling machine comprising a frame and a drill secured to the frame, the method comprising:
removably but rigidly coupling the frame to a first anchor point comprising a first vehicle adapted to transport the frame;
optionally removably but rigidly coupling the frame to a second anchor point;
providing a force on the frame in a direction away from the surface such that the frame is rigidly fixed between the surface and at least the first anchor point; and
operating the drill to perform a drilling process to remove the material from the surface.

23. The method of claim 22, wherein the method comprises removably but rigidly coupling the frame to the second anchor point and the second anchor port is a second vehicle.

24. The method of claim 22, wherein the surface is a wall.

25. The method of claim 22, wherein the surface is underwater.
